(19) United States
(12) Patent Application Publication
(10) Pub. No.: US 2022/0398542 A1
(43) Pub. Date: Dec. 15, 2022

(54) System and Method for Generating Cue Sheets

(71) Applicant: Complete Cue Sheets LLC, Simi Valley, CA (US)

(72) Inventors: RICHARD LIVINGSTONE, St. Augustine, FL (US); GREGORY SWEENEY, Hoboken, NJ (US)

(73) Assignee: Complete Cue Sheets LLC, Simi Valley, CA (US)

(21) Appl. No.: 17/775,180

(22) PCT Filed: Nov. 25, 2020
(86) PCT No.: PCT/US2020/062171

§ 371 Date: May 6, 2022

Related U.S. Application Data
(60) Provisional application No. 62/940,332, filed on Nov. 26, 2019.

(51) Int. Cl. G06Q 10/10; G06Q 40/00

(52) U.S. Cl. CPC G06Q 10/1091; G06Q 40/125

(57) ABSTRACT

A system and method for generating a cue sheet for submission to a performing rights organization. The system comprising a processor for executing the steps of: receiving an electronic file associated with a broadcast production comprising a list of cues used in the broadcast production and associated use data; extracting irrelevant data from the electronic file by determining and deleting irrelevant cues, determining and deleting unnecessary and unrelated use data from each cue, and determining and deleting duplicative cues, so that relevant cues and associated use data remain after extracting; searching a music catalog database to retrieve identification data for each relevant cue; storing each relevant cue with its associated use data and identification data in a memory; and generating a cue sheet comprising relevant cues with associated use data and identification data for each relevant cue.

### CROSS-REFERENCE TO RELATED APPLICATION

The present application claims priority to U.S. Provisional Application No. 62/940,332, titled “System and Method for Generating Cue Sheets,” filed on Nov. 26, 2019, which is incorporated by reference in its entirety.

### FIELD

The present disclosure relates to cue sheets and in particular to a system and method for generating cue sheets.

### BACKGROUND

Cue sheets are utilized in the entertainment and production industries to track the musical cues, such as songs, background music, and sound snippets, which are used in a television program or a film. By tracking the cues using the cue sheets, composers and publishers of the cues can be compensated financially, via performing rights organizations, using the data in the cue sheets.

Methods in the prior art to generate cue sheets have been primarily manually implemented, which may generate errors in the accumulation and processing of cue data.

A need exists for a system and method for generating accurate cue sheets.

Even with some automation and computerization to improve accuracy, such prior art systems and methods would take, for example, from 2.5 hours to 4.5 hours to complete a single television episode with numerous musical cues. This is because in prior art systems and methods, cue sheets are generated without sufficient analysis and processing of information. Therefore, generated cue sheets require further manual labor before the cue sheets are finalized into accurate form.

A need exists for a faster and more automated system and method for quickly generating accurate cue sheets.

### SUMMARY

The following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented later.

In the present invention, a cue sheet creator computer receives a user input in the form of a text file including cues, which is then processed by a cue sheet creator computer, matching the cues to previously-stored composer and publisher information, in order to create a MICROSOFT EXCEL spreadsheet as the final cue sheet. The spreadsheet is then processed by a third-party such as a payment system to accurately pay composers and publishers for the cues used in a television or film production.

In one aspect, the present invention provides a computer-implemented method for generating a cue sheet for submission to a performing rights organization, comprising executing on a processor the steps of: receiving an electronic file associated with a broadcast production, the electronic file comprising a list of cues used in the broadcast production and associated use data, the use data for each cue comprising a cue title, start time, end time and duration of use; extracting irrelevant data from the electronic file, wherein the extracting comprises: determining and deleting irrelevant cues, determining and deleting unnecessary and unrelated use data from each cue, and determining and deleting duplicative cues, wherein relevant cues and associated use data remain after extracting; searching a music catalog database to retrieve identification data for each relevant cue, the identification data comprising a composer, a publisher and a performing rights organization affiliated with the relevant cue; storing each relevant cue with its associated use data and identification data in a memory; and generating a cue sheet comprising relevant cues with associated use data and identification data for each relevant cue.

In another aspect, the present provides a system for generating a cue sheet for submission to a performing rights organization, the system comprising: a memory receiving an electronic file associated with a broadcast production, the electronic file comprising a list of cues used in the broadcast production and associated use data, the use data for each cue comprising a cue title, start time, end time and duration of use; and a processor executing the steps of: (i) receiving an electronic file associated with a broadcast production, the electronic file comprising a list of cues used in the broadcast production and associated use data, the use data for each cue comprising a cue title, start time, end time and duration of use; (ii) extracting irrelevant data from the electronic file, wherein the extracting comprises: determining and deleting irrelevant cues, determining and deleting unnecessary and unrelated use data from each cue, and determining and deleting duplicative cues, wherein relevant cues and associated use data remain after extracting; (iii) searching a music catalog database to retrieve identification data for each relevant cue, the identification data comprising a composer, a publisher and a performing rights organization affiliated with the relevant cue; (iv) storing each relevant cue with its associated use data and identification data in the memory; and (v) generating a cue sheet comprising relevant cues with associated use data and identification data for each relevant cue.

In yet another aspect, the present invention provides a non-transitory computer-readable medium for generating a cue sheet for submission to a performing rights organization, comprising instructions stored thereon, that when executed on a processor, perform the steps of: receiving an electronic file associated with a broadcast production, the electronic file comprising a list of cues used in the broadcast production and associated use data, the use data for each cue comprising a cue title, start time, end time and duration of use; extracting irrelevant data from the electronic file, wherein the extracting comprises: determining and deleting irrelevant cues, determining and deleting unnecessary and unrelated use data from each cue, and determining and deleting duplicative cues, wherein relevant cues and associated use data remain after extracting; searching a music catalog database to retrieve identification data for each relevant cue, the identification data comprising a composer, a publisher and a performing rights organization affiliated with the relevant cue; storing each relevant cue with its associated use data and identification data in a memory; and generating a cue sheet comprising relevant cues with associated use data and identification data for each relevant cue.

### BRIEF DESCRIPTION OF DRAWINGS

The foregoing summary, as well as the following detailed description of presently preferred embodiments of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown.

In the drawings:

FIG. 1 is a schematic of the system of the present invention;

FIGS. 2A-2C is a flowchart of operation of the system of FIG. 1;

FIG. 3 is a screenshot of an interface for a user to create a project;

FIG. 4 is a screenshot showing stored cues;

FIG. 5 is a screenshot of an interface for a user to specify processing settings;

FIG. 6 is a screenshot of a specific stored cue;

FIG. 7 is a screenshot of an interface for specifying how to process matching cues;

FIG. 8 is a screenshot of a system status message;

FIG. 9 is a screenshot showing imported cues;

FIG. 10 is a screenshot of an importation status message;

FIG. 11 is a screenshot of an interface showing imported cues; and

FIGS. 12-13 are screenshots of interfaces for editing cues.

To facilitate an understanding of the invention, identical reference numerals have been used, when appropriate, to designate the same or similar elements that are common to the figures. Further, unless stated otherwise, the features shown in the figures are not drawn to scale and are shown for illustrative purposes only.

### DETAILED DESCRIPTION

Certain terminology is used in the following description for convenience only and is not limiting. The article “a” is intended to include one or more items, and where only one item is intended the term “one” or similar language is used. Additionally, to assist in the description of the present invention, words such as top, bottom, side, upper, lower, front, rear, inner, outer, right and left may be used to describe the accompanying figures. The terminology includes the words above specifically mentioned, derivatives thereof, and words of similar import.

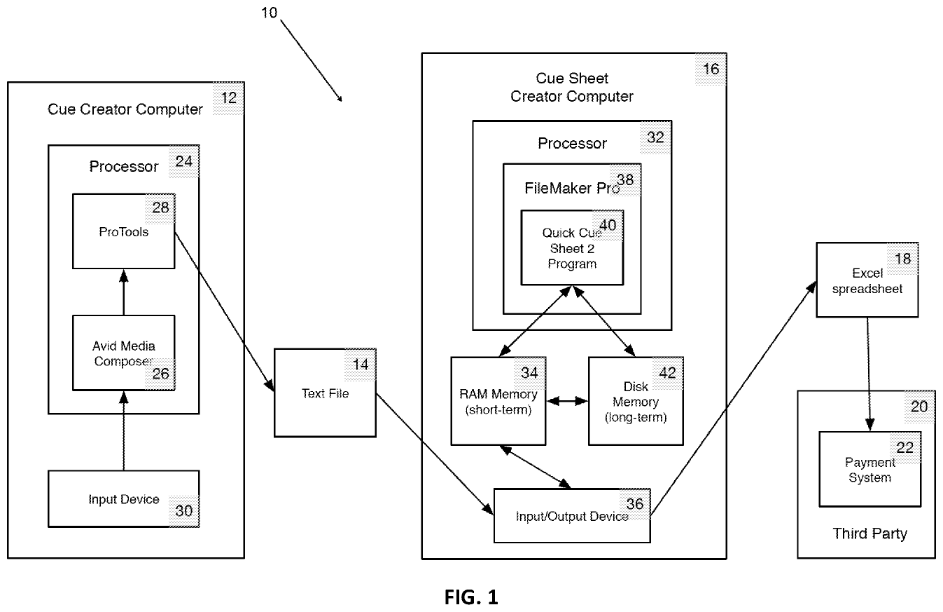

Referring to FIG. 1, the system 10 includes a cue creator computer 12 which sends an electronic file, preferably a text file 14, to a cue sheet creator computer 16, which in turn creates a cue sheet in a MICROSOFT EXCEL spreadsheet 18. The spreadsheet 18 is then provided to a third party 20, such as a payment system 22, which may be any known system for paying others such as electronic payment systems, and which ensures that music and media composers are paid for their music used as cues. For example, the cue sheet creator computer 16 may be connected to the third party 20, and in particular to the payment system 22, through a network, such as the Internet, for transmitting the cue sheet as a MICROSOFT EXCEL spreadsheet 18 from the cue sheet creator computer 16 to the third party 20 and/or to the payment system 22. One of ordinary skill in the art will recognize that other forms of output are possible, for example, a text file (e.g., Microsoft Word), PDF, HTML, etc.

The cue creator computer 12 includes a processor 24 executing the AVID MEDIA COMPOSER application 26 and the PROTOOLS application 28. The AVID MEDIA COMPOSER application 26 receives inputs from an input device 30, such as cue information provided by networks and television production companies. The AVID MEDIA COMPOSER application 26 generates a file with an “.aaf” extension, which is then converted by the PROTOOLS application 28 to be the text file 14 having a “.txt” extension.

The text file 14 is transmitted or otherwise conveyed to the cue sheet creator computer 16. For example, the cue creator computer 12 may be connected to the cue sheet creator computer 16 through a network, such as the Internet, for transmitting the text file 14 from the cue creator computer 12 to the cue sheet creator computer 16. The cue sheet creator computer 16 has a processor 32, a memory 34, and an input/output device 36. The processor 32 executes the FILEMAKER PRO application 38, which is an application platform for running a quick cue sheet program 40 and which generates the cue sheet in the MICROSOFT EXCEL spreadsheet 18.

In an example embodiment, the cue creator computer 12 as well as the cue creator computer 16 may be an APPLE IMAC, an APPLE MACBOOK PRO, or an ASUS personal computer. The processor 24 as well as the processor 32 may be a 1 GHz or faster x86-bit or x64-bit microprocessor, or a 1.4 GHz quad-core INTEL CORE 15 microprocessor. The memory 34 may be at least 1 GB of RAM. The operating system of the cue creator computer 12 as well as the cue creator computer 16 may use, as an operating system, MICROSOFT WINDOWS 7 or a higher version, APPLE MACOS MOJAVE 10.14, or APPLE MACOS HIGH SIERRA 10.13. The FILEMAKER PRO application 38 may be any version of FILEMAKER PRO, commercially available from CLARIS INTERNATIONAL, a subsidiary of APPLE INC., such as FILEMAKER PRO 16, FILEMAKER PRO 17, and FILEMAKER PRO ADVANCED 18.

When the text file 14 is imported into the cue sheet creator computer 16, the text file 14 is imported into a FILEMAKER PRO database and stored on the disk 42. When required for processing, the data is moved into the memory 34 for ready access and use by the program 40 and/or by FILEMAKER PRO 38. Composer and publisher information obtained from specific music library companies, i.e., music catalogs, is stored on the disk 42, for ready access and use by the program 40 and/or by FILEMAKER PRO 38. Such local storage provides working space to combine the cue information with the previously stored composer and publisher information by using the processor 32 and the program 40 to process the text file 14. The memory 34 and the disk 42 may store the text file 14 and the composer and publisher information in text format, such as using the Unicode data format. The disk 42 may also be used by FILEMAKER PRO 38 to store and manage temporary cache files. The disk 42 also provides long term storage of cue information to allow for reprocessing of cue information when desired. In the event that information for a particular cue is not located in the music catalog or database stored on the disk 42, for example, a recently released cue, then the database is updated with the new cue.

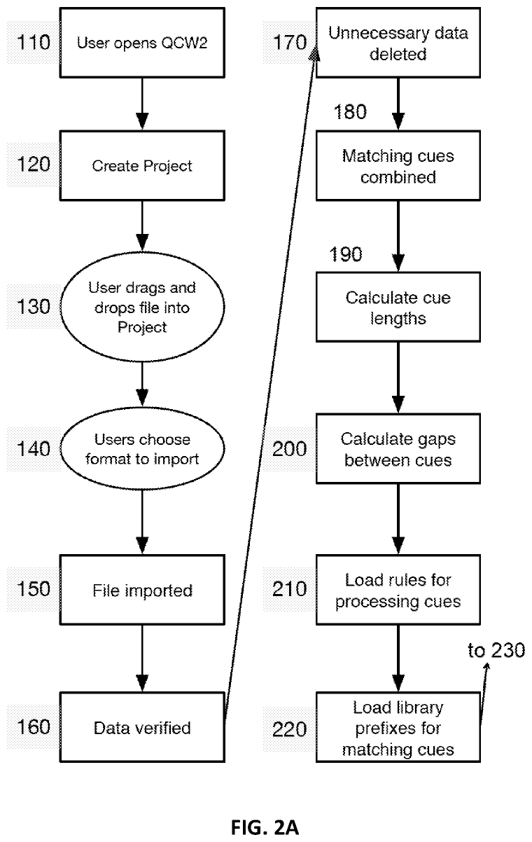

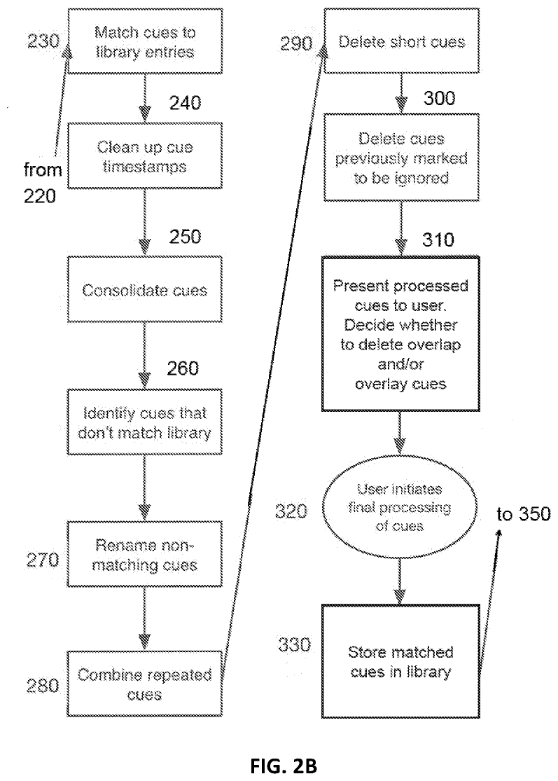

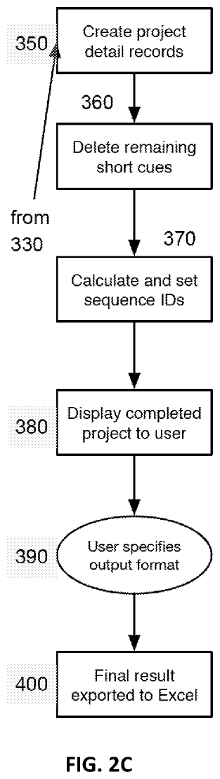

Referring to FIGS. 2A-2C, the system 10 of the present invention operates to perform the method 100, which generally has five stages: (i) manually tweak, if necessary, information to be imported using settings which are automatically applied to process the text file 14; (ii) import the text file 14 via a drag and drop interface in a graphical user interface (GUI); (iii) perform initial processing of the imported text file 14; (iv) perform final processing of the data into a completed cue sheet; and (v) output or export the cue sheet in a desired format such as a MICROSOFT EXCEL spreadsheet 18.

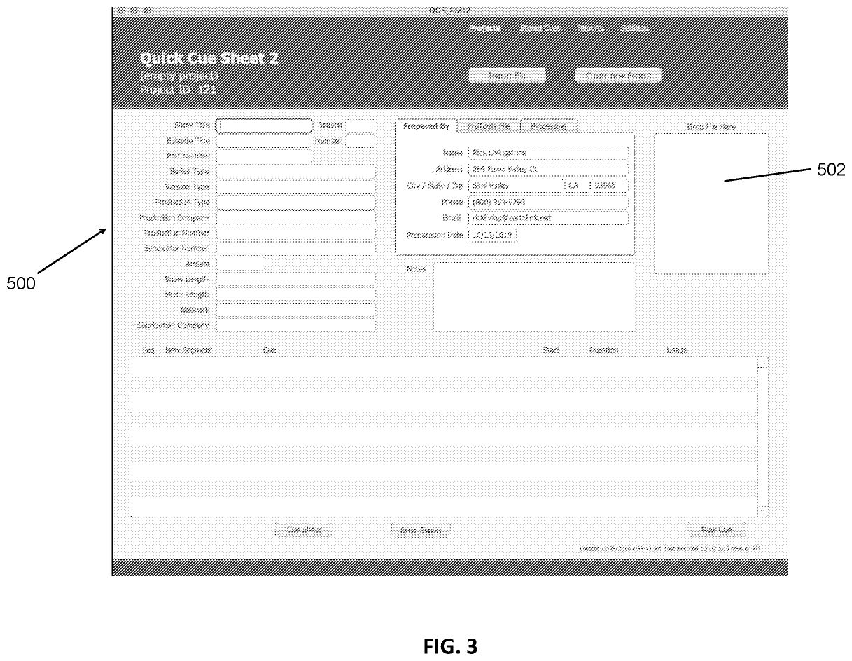

Still referring to FIGS. 2A-2C, the method 100 begins with the step 110 in which the user opens the program 40, referred to herein as a quick cue sheet (QCS) or a quick cue sheet workflow 2 (QCW2) program. The method 100 then creates a project in step 120, using the interface 500 as shown in FIG. 3. The interface 500 may be a GUI, which the user accesses by the input device 30 in FIG. 1. With the interface 500, the user enters data into various input fields to specify a show title, a season number, an episode title, an episode number, a part number, etc.

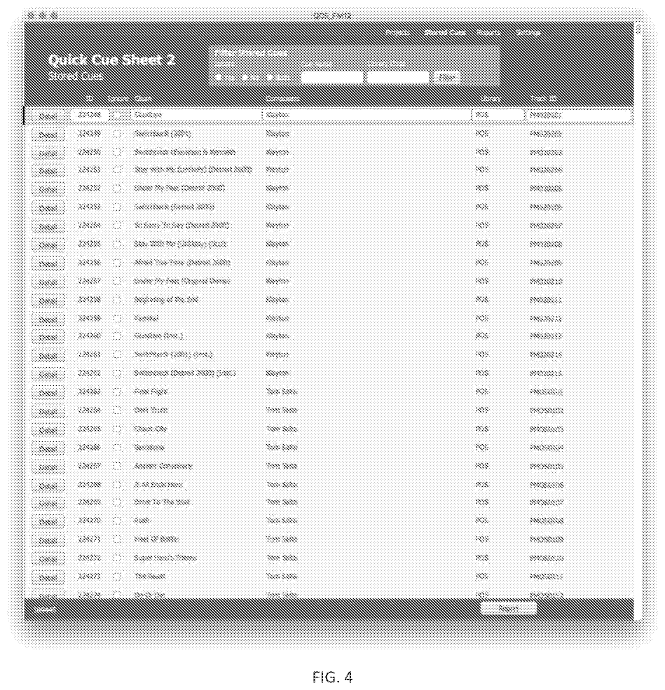

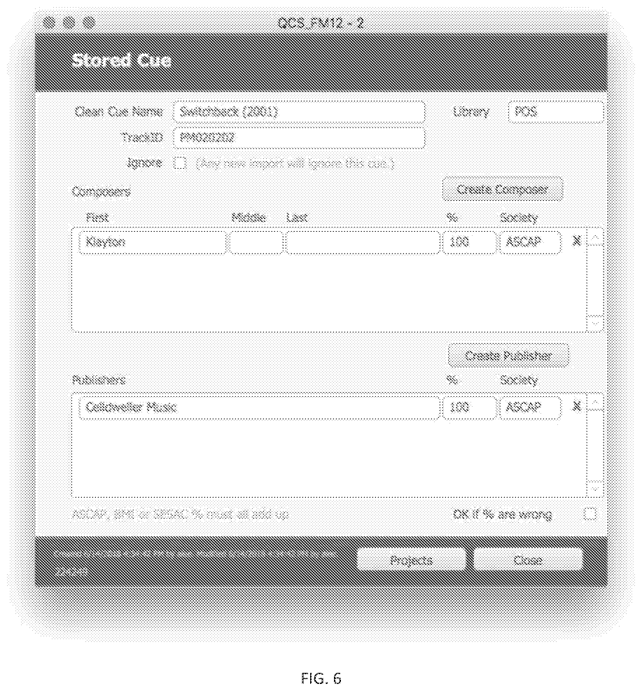

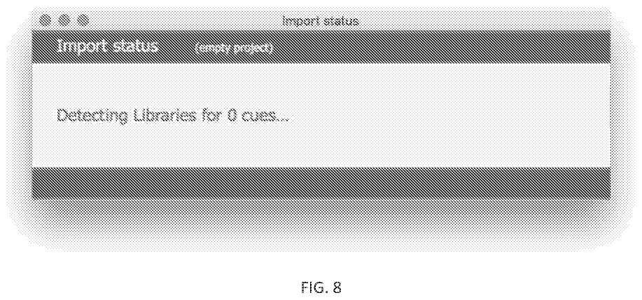

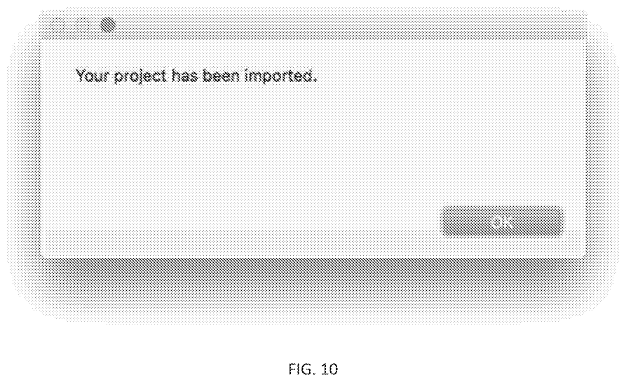

In addition, a region 502 of the interface 500 is provided for receiving the text file 14. To import the text file 14 into the project, the user drags and drops the text file 14 into the region 502, and the processor 32 then processes the text file 14, as described herein. For example, the cues and related information may be formatted as shown in FIGS. 4 and 6. The user then chooses the format to input data in step 140, from among several different text formats such as standard, edit decision list (EDL), and EDL2. The text file 14 is imported in step 150, and an import status message may be displayed to the user, such as shown in FIGS. 8 and 10.

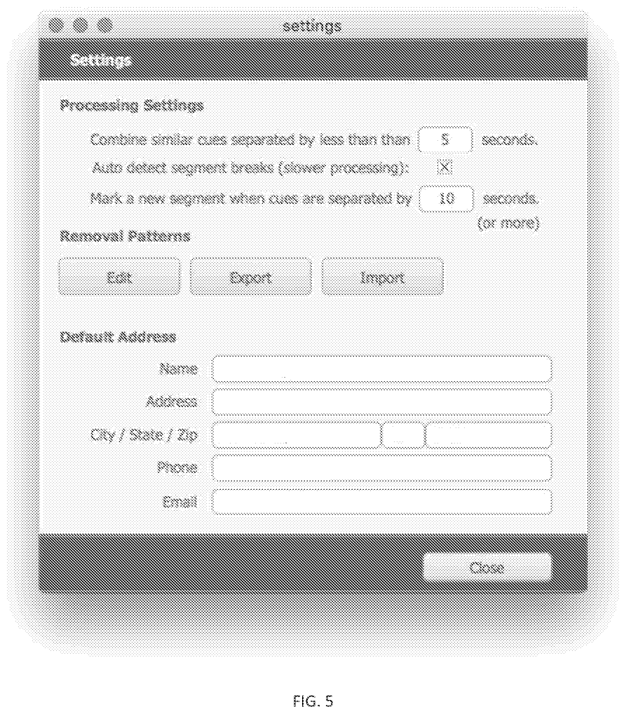

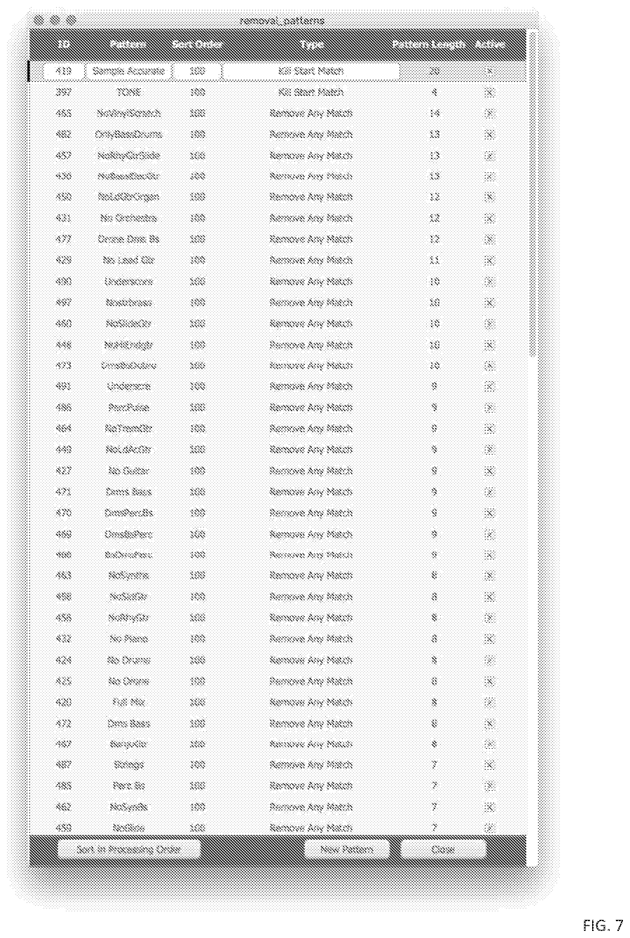

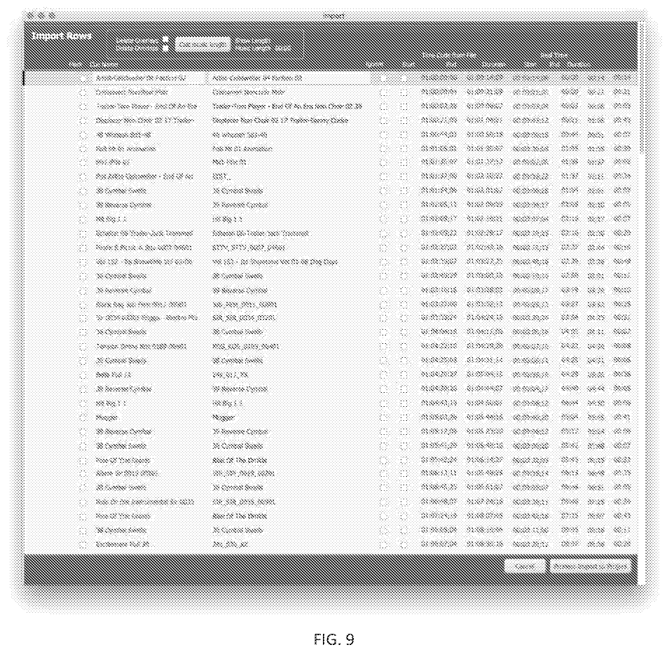

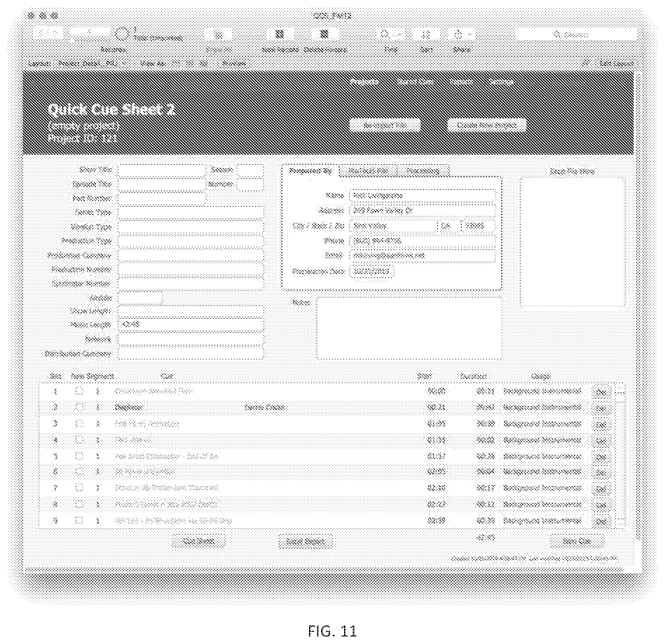

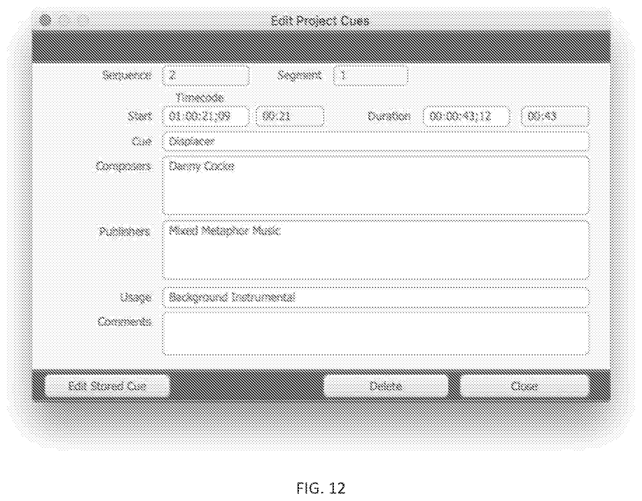

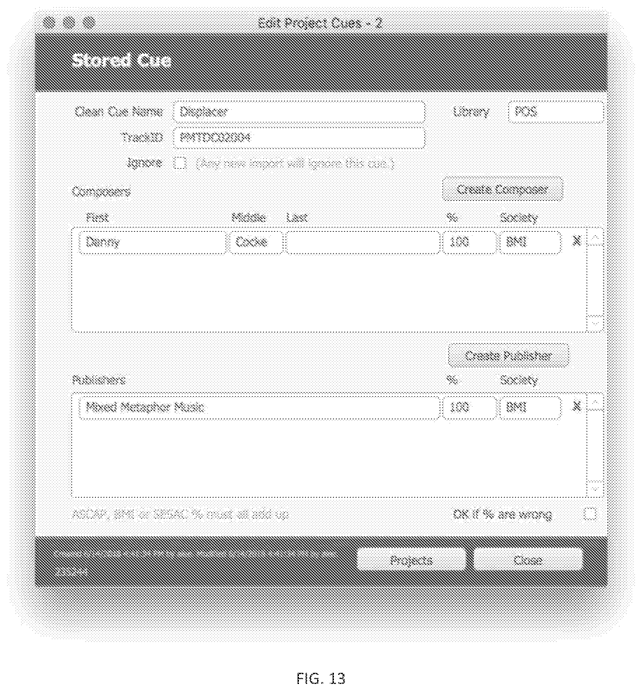

Also, the user may specify settings using the GUI as shown in FIG. 5, by which criteria are indicated by the user to control combining of cues or marking new segments, as well as removal patterns. FIG. 7 illustrates cues and their removal settings. As shown in FIGS. 9 and 11-13, the imported cues may be displayed to the user in a row and column format, and so the user can select individual cues using the interfaces in FIGS. 9 and 11, and edit the selected cues using the interfaces in FIGS. 12-13.

Referring back to FIGS. 2A-2C, the data in the text file 14 is verified in step 160. Since the program 40 expects to see specific data in specific places in the text file 14, if such data is not in such places, processing the text file 14 will fail. For example, the first line in the text file 14 must start with “SESSION NAME” and the second line must start with “SAMPLE RATE”. If such lines do not have such mandatory labels or information, the processing will fail. Accordingly, in step 160, the verification confirms that the format of the text file 14 has the expected data in the proper format, so that the data can be processed.

Unnecessary data is deleted in step 170, such as tracks marked “inactive”, or mixes having multiple versions which are designated as “.x1”. In addition, non-cue related data may lack timecode information or may have a duration of zero, and so such non-cue related data are deemed unnecessary, and then are deleted. However, lines that are non-duplicative tracks which do not have an inactive state are kept for processing.

Matching cues are combined in step 180, for example, cues are combined if the space between the end of the first cue is less than a user-specified duration. In addition, fade-ins and fade-outs are imported as separate cues, and when detected, such fade-ins and fade-outs are merged with the main cue. Also, a user-configurable set of text strings may be used to filter out unnecessary or redundant data, such as when the same cue has multiple versions, but which need to be treated as the same thing. For example, there might be versions of a song “X” named “X_Nostrbrass”, “X_OnlyBassDrums”, “X_No_Guitar”, “X No Piano”, etc. The program 40 uses removal pattern strings to instruct the system 10 to ignore these variations and to consider the underlying music as a single cue.

To combine matching cues, if matching cues have the same start time, then one of the matching cues is deleted. Also, if the gap between the start and end times of matching cues falls within a user-defined value, then the time durations are combined, and the extraneous cue is deleted. For example, the same cue might be used more than once during the duration of the show.

The method 100 then calculates cue lengths in step 190, by calculating their start and end times from the beginning of any fade-in to the end of any fade-out. The method 100 then calculates gaps between cues in step 200 by looping through all the potential matches and calculating the gap between the potential matches. For each gap, if the duration is greater than a predetermined value, “import segment” records are created which hold the start time and end time of each segment. The predetermined value is set by the user in a configuration menu or settings GUI, displayed by the input/output device 36.

In addition, the method 100 loads rules for processing cues in step 210, such that cue names are cleaned up, cues with duplicate names are removed, and cues with missing track names are also removed. For example, an underline such as “ ” is changed to a space in order to catch potential duplicate names. Library prefixes for matching cues are then loaded in step 220, with such library prefixes being codes found in track names, such as “24s” or “STS”, which tell the system 10 that the cue is part of the 24s Music Library or the Stage to Screen library, respectively. Cues are matched with library entries in step 230, such that once a library prefix of a cue is matched, then the system 10 looks for further patterns in the track name to determine whether the cue can be matched with an entry in the respective library. The patterns are based on a minimum number of parameters, since sometimes the omission of certain parts of the pattern dictates a different route to take in order to match the cue to the entry in the library. In the event that a cue is not matched, a manual entry is made to the file.

Cue timestamps are cleaned up in step 240 by trimming off excess spaces. Cues are then consolidated in step 250 if the names of cues match, and the durations are combined if the gap between durations are smaller than a user-defined value. Then the method 100 checks for cues that do not match the library entries, and such cues are identified in step 260. Besides cues that do not match any library entity, various parameters are also examined to be present or to be missing.

Non-matching cues are renamed in step 270, such that cue names are cleaned up by a number of rules set by removal patterns. For example, when a “.wav” is detected in a cue name, the cue and anything else that follows the cue are deleted. Repeated cues are combined in step 280, with such combining of cues described above. In addition, short cues having a duration less than or equal to one second, from start time to end time, are deleted in step 290. The setting of one second may be user-adjustable, such as by using the interface in FIG. 5.

Cues which were previously marked by the end user to be ignored, for example, using the interface in FIG. 4, are deleted in step 300. Processed cues are then presented to the user in step 310, sorted by ascending start time, using the input/output device 36.

As shown in FIG. 9 and step 310 in FIG. 2B, in order to prevent the music running time from exceeding the show running time, the user has the option to delete overlapping and/or overlayed cues. Any cue which has a start time before the end time of the preceding cue, and has an end time occurring after the end time of the preceding cue is an overlap, in which case the end time of the first cue (if the option to delete overlapping cues is selected) will be set to the start time of the subsequent cue. Any cue which has a start time and end time fully encompassed with the start and end time of another cue is an overlay, in which case (if the option to delete overlaying cues is selected) the cue encompassed within the larger cue is deleted. This inventive feature is particularly advantageous because performing rights organizations permit overlapping and overlayed cues as long as the total running time of music does not exceed the total running time of the show.

The user initiates the final processing of cues in step 320. Matched cues are stored in the library maintained by FILEMAKER PRO application 38 in step 330, which may in turn store the library on the disk 42. Project detail records are created in step 350, which includes information gathered by the PROTOOLS application 28, such as sequence number, cue name, composer information, publisher information, start time, end time, and duration. Any remaining short cues are deleted in step 360, and sequence IDs are created and set in step 370, as short cues, usually under one second, are not normally considered for royalty payments. The sequence IDs are calculated and created by sorting the cues in order of start time, and then the cues are given a sequential Sequence ID using the import segment records created in step 200.

The completed project to be the cue sheet is then displayed to the user with a list of cues being sorted by start time, using the input/output device 36 in step 380. The completed project contains a list of cue names; composer names; publisher names; composer percentages; publisher percentages; composer professional affiliation such as ASCAP, BMI, and SESAC; publisher professional affiliation such as ASCAP, BMI, and SESAC; cue start time; cue end time; and cue durations. The processor 32 performs statistical analysis to determine such percentages. The user specifies the format to output the cue sheet in step 390, which may be variations in the MICROSOFT EXCEL format as required by third parties 20 for their payment system 22. The final result is exported to MICROSOFT EXCEL in step 400 to create the spreadsheet 18. Such a cue sheet is used by entities, such as rights management personnel, to ensure proper and accurate payment of royalties to composers and publishers through a third party using the payment system 22. Such third parties may be the American Society of Composers, Authors, and Publishers (ASCAP); Broadcast Music, Inc. (BMI), and the Society of European Stage Authors and Composers (SESAC). The payment system 22 may be an automated billing and/or fulfillment system, known in the art, for electronically delivering fees and royalties to composers and publishers using the percentages determined and saved in the cue sheet of the spreadsheet 18.

The system 10 and method 100 of the present invention have a rapid throughput of the text file 14 being converted to a cue sheet in a MICROSOFT EXCEL spreadsheet 18, since the program 40 processes the imported text file 14 locally. In addition, the method 100 is relatively streamlined for speed, and may take less than five minutes to process the text file 14 to output the cue sheet in the spreadsheet 18, especially since unnecessary data and short cues are deleted, and so are not further processed. One skilled in the art would recognize that the speed of processing by the method 100 using the system 10 may be further increased by using faster and/or additional processors 32, as well as using co-processors, customized or specialized hardware, or application-specific integrated circuits (ASICs) in the cue sheet creator computer 16.

The present invention may be embodied in other specific forms without departing from its spirit or essential characteristics. The described embodiments are to be considered in all respects only as illustrative and not restrictive. The scope of the invention, therefore, will be indicated by claims rather than by the foregoing description. All changes, which come within the meaning and range of equivalency of the claims, are to be embraced within their scope.

1. A computer-implemented method for generating a cue sheet for submission to a performing rights organization, comprising executing on a processor the steps of:
receiving an electronic file associated with a broadcast production, the electronic file comprising a list of cues used in the broadcast production and associated use data, the use data for each cue comprising a cue title, start time, end time and duration of use;
extracting irrelevant data from the electronic file, wherein the extracting comprises:
determining and deleting irrelevant cues,
determining and deleting unnecessary and unrelated use data from each cue, and
determining and deleting duplicative cues,
wherein relevant cues and associated use data remain after extracting;
searching a music catalog database to retrieve identification data for each relevant cue, the identification data comprising a composer, a publisher and a performing rights organization affiliated with the relevant cue;
storing each relevant cue with its associated use data and identification data in a memory; and
generating a cue sheet comprising relevant cues with associated use data and identification data for each relevant cue.

2. The method of claim 1, further comprising the step of creating a project file associated with the electronic file, the project file comprising one or more of: a name of the broadcast production, a network airing the broadcast production, a production company of the broadcast production, a producer, a length of the broadcast production and an airing date of the broadcast production.

3. The method of claim 1, further comprising the step of determining whether a relevant cue is an overlapping cue and if so, deleting the overlapping cue and resetting the end time of a preceding relevant cue as the start time of the overlapping cue.

4. The method of claim 1, further comprising the step of determining whether a relevant cue is an overlaying cue and if so, deleting the overlaying cue.

5. The method of claim 1, further comprising the step of transmitting the cue sheet to a payment processor for payment of royalties to the performing rights organization.

6. The method of claim 1, wherein the electronic file is a text file.

7. The method of claim 1, wherein the irrelevant data comprises one or more of: prefixes of a cue title, suffixes of a cue title, fade-in cues, fade-out cues, and cues having a duration less than a pre-determined amount of time.

8. A system for generating a cue sheet for submission to a performing rights organization, the system comprising:
a memory receiving an electronic file associated with a broadcast production, the electronic file comprising a list of cues used in the broadcast production and associated use data, the use data for each cue comprising a cue title, start time, end time and duration of use; and
a processor executing the steps of:
(i) receiving an electronic file associated with a broadcast production, the electronic file comprising a list of cues used in the broadcast production and associated use data, the use data for each cue comprising a cue title, start time, end time and duration of use;
(ii) extracting irrelevant data from the electronic file, wherein the extracting comprises:
determining and deleting irrelevant cues,
determining and deleting unnecessary and unrelated use data from each cue, and
determining and deleting duplicative cues,
wherein relevant cues and associated use data remain after extracting;
(iii) searching a music catalog database to retrieve identification data for each relevant cue, the identification data comprising a composer, a publisher and a performing rights organization affiliated with the relevant cue;
(iv) storing each relevant cue with its associated use data and identification data in the memory; and
(v) generating a cue sheet comprising relevant cues with associated use data and identification data for each relevant cue.

9. The system of claim 8, wherein the processor further executes the step of determining whether a relevant cue is an overlapping cue and if so, deleting the overlapping cue and resetting the end time of a preceding relevant cue as the start time of the overlapping cue.

10. The system of claim 8, wherein the processor further executes the step of determining whether a relevant cue is an overlaying cue and if so, deleting the overlaying cue.

11. The system of claim 8, wherein the processor further executes the step of transmitting the cue sheet to a payment processor for payment of royalties to the performing rights organization.

12. The system of claim 8, wherein the electronic file is a text file.

13. The system of claim 8, wherein the irrelevant data comprises one or more of: prefixes of a cue title, suffixes of a cue title, fade-in cues, fade-out cues, and cues having a duration less than a pre-determined amount of time.

14. A non-transitory computer-readable medium for generating a cue sheet for submission to a performing rights organization, comprising instructions stored thereon, that when executed on a processor, perform the steps of:
receiving an electronic file associated with a broadcast production, the electronic file comprising a list of cues used in the broadcast production and associated use data, the use data for each cue comprising a cue title, start time, end time and duration of use;
extracting irrelevant data from the electronic file, wherein the extracting comprises:
determining and deleting irrelevant cues,
determining and deleting unnecessary and unrelated use data from each cue, and
determining and deleting duplicative cues,
wherein relevant cues and associated use data remain after extracting;
searching a music catalog database to retrieve identification data for each relevant cue, the identification data comprising a composer, a publisher and a performing rights organization affiliated with the relevant cue;
storing each relevant cue with its associated use data and identification data in a memory; and
generating a cue sheet comprising relevant cues with associated use data and identification data for each relevant cue.

15. The non-transitory computer-readable medium of claim 8, further comprising the step of creating a project file associated with the electronic file, the project file comprising one or more of: a name of the broadcast production, a network airing the broadcast production, a production company of the broadcast production, a producer, a length of the broadcast production and an airing date of the broadcast production.

16. The non-transitory computer-readable medium of claim 8, further comprising the step of determining whether a relevant cue is an overlapping cue and if so, deleting the overlapping cue and resetting the end time of a preceding relevant cue as the start time of the overlapping cue.

17. The non-transitory computer-readable medium of claim 8, further comprising the step of determining whether a relevant cue is an overlaying cue and if so, deleting the overlaying cue.

18. The non-transitory computer-readable medium of claim 8, further comprising the step of transmitting the cue sheet to a payment processor for payment of royalties to the performing rights organization.

19. The non-transitory computer-readable medium of claim 8, wherein the electronic file is a text file.

20. The non-transitory computer-readable medium of claim 8, wherein the irrelevant data comprises one or more of: prefixes of a cue title, suffixes of a cue title, fade-in cues, fade-out cues, and cues having a duration less than a pre-determined amount of time.
